(19) United States
(12) Patent Application Publication
(10) Pub. No.: US 2007/0200992 A1
(43) Pub. Date: Aug. 30, 2007

(54) LCD display device having dummy pixels

(76) Inventors: Chul-Ho Kim, Yongin-si (KR); Il-Gon Kim, Seoul (KR); Cheol-Min Kim, Seoul (KR)

Correspondence Address: CANTOR COLBURN, LLP, 55 GRIFFIN ROAD SOUTH, BLOOMFIELD, CT, 06002, US

(21) Appl. No.: 11/521,777

(22) Filed: Sep. 15, 2006

(30) Foreign Application Priority Data
Feb. 27, 2006 (KR) 10-2006-0018851

(51) Int. Cl. G02F 1/1343

(52) U.S. Cl. 349/143

(57) ABSTRACT

A display device is provided. The display device includes a display area having display pixels arranged in a matrix shape, and a dummy area that is formed proximate to an edge of the display area and that has a plurality of dummy pixels. Each dummy pixel includes a first electrode, a second electrode for receiving a common voltage, a liquid crystal layer formed between the first electrode and the second electrode, and a voltage supplier for supplying the first voltage to the first electrode. By removing a thin film transistor of a dummy pixel and directly applying a common voltage to a pixel electrode, the thin film transistor of the dummy pixel is destroyed when static electricity is introduced from the outside, thereby preventing static electricity from being introduced to the display area.

### CROSS-REFERENCE TO RELATED APPLICATION

This application claims priority to Korean Patent Application No. 10-2006-0018851 filed in the Korean Intellectual Property Office on Feb. 27, 2006, and all of the benefits accruing therefrom under 35 U.S.C. §119, the entire disclosure of which is incorporated herein by reference.

### BACKGROUND OF THE INVENTION

(a) Field of the Invention

The present invention relates to liquid crystal displays.

(b) Description of the Related Art

Recently, the decrease in weight and thickness of personal computers, televisions, and other electronic equipment has required a decrease in weight and thickness of display devices. Accordingly, cathode ray tubes (CRT) are presently being replaced with flat panel displays.

Types of panel displays include a liquid crystal display (LCD), a field emission display (FED), an organic light emitting display (OLED), a plasma display panel (PDP), and so on.

In general, in an active matrix type of flat panel display, a plurality of display pixels are arranged in a matrix shape and an image is displayed by controlling illumination strength of each display pixel depending on given luminance information. The liquid crystal display includes a substrate with pixel electrodes, a substrate with common electrodes, and a liquid crystal layer that has dielectric anisotropy and which is interposed between the two aforementioned substrates. The liquid crystal display obtains an image by adjusting transmittance of light that passes through the liquid crystal layer by applying an electric field to the liquid crystal layer and adjusting intensity of the electric field.

The liquid crystal display supplies a common voltage to a lower substrate in which a pixel electrode is formed, and transfers the common voltage to a common electrode of an upper substrate through an electrical shorting point of the lower substrate. A fault, generated as static electricity that is introduced to the electrical shorting point, is introduced to the display pixel of the lower substrate in a rubbing process.

The above information disclosed in this Background section is only for enhancement of understanding of the background of the invention and therefore it may contain information that does not form the prior art that is already known to a person of ordinary skill in the art.

### SUMMARY OF THE INVENTION

One aspect of the present invention provides a liquid crystal display for minimizing failures due to static electricity.

One exemplary embodiment of the present invention provides a display device including: a display area having display pixels arranged in a matrix shape; a dummy area that is formed proximate to an edge of the display area and that has a plurality of dummy pixels, each dummy pixel including a first electrode. A second electrode faces the first electrode and receives a common voltage. A liquid crystal layer is formed between the first electrode and the second electrode; and a voltage supplier supplies a first voltage to the first electrode.

The first voltage may be the common voltage.

The dummy pixel may include a plurality of first dummy pixels that are formed in a column direction in left/right edge regions of the display area, and a plurality of second dummy pixels that are formed in a row direction in upper/lower edge regions of the display area.

The voltage supplier may include a dummy data line that crosses the first dummy pixel.

The dummy data line may supply the common voltage that is supplied to the second electrode to the first electrode.

The second dummy pixel may further include a sustain electrode line that is connected to each second dummy pixel to transfer the common voltage to the second dummy pixel.

The voltage supplier of the second dummy pixel may transfer the common voltage of the storage electrode line to the first electrode.

The liquid crystal layer may transmit light of the highest gray level when a potential difference between the first electrode and the second electrode is about 0V.

Another embodiment of the present invention provides a display device including a dummy area that is formed proximate to an edge of a display panel arranged in a matrix shape. The dummy area includes a plurality of dummy pixels. The dummy pixels each include a voltage supplier for transferring a common voltage; a first insulating layer that is formed on the voltage supplier and that includes a contact hole for exposing the voltage supplier; a first electrode that is formed on the first insulating layer and that is connected to the voltage supplier through the contact hole; a second electrode facing the first electrode and receiving a common voltage; and a liquid crystal layer formed between the first electrode and the second electrode.

The plurality of dummy pixels may include a plurality of first dummy pixels that are formed in a column direction proximate to left/right edge regions of the display panel, and a plurality of second dummy pixels that are formed in a row direction proximate to upper/lower edge regions of the display panel.

The voltage supplier of the first dummy pixel may supply the common voltage that is supplied to the second electrode to the first electrode.

The second dummy pixel may further include a storage electrode that supplies the common voltage and that is formed under the voltage supplier.

The second dummy pixel may further include a second insulating layer that includes a contact hole for connecting the storage electrode and the voltage supplier on the storage electrode.

The liquid crystal layer may transmit light of the highest gray level when the potential difference between the first electrode and the second electrode is about 0V.

### BRIEF DESCRIPTION OF THE DRAWINGS

FIG. 1 is a block diagram of a liquid crystal display according to an illustrative embodiment of the present invention.

FIG. 2 is an equivalent circuit diagram of a display pixel of a liquid crystal display according to an illustrative embodiment of the present invention.

FIG. 3 is a layout view of a display pixel of a liquid crystal display according to an illustrative embodiment of the present invention.

FIG. 4 is a cross-sectional view of a liquid crystal display taken along line IV-IV of FIG. 3.

FIGS. 5A and 5B are equivalent circuit diagrams of a dummy pixel according to an illustrative embodiment of the present invention.

FIG. 6 is a layout view of a dummy pixel according to an illustrative embodiment of the present invention.

FIG. 7 is a cross-sectional view of a liquid crystal display taken along line VII-VII of FIG. 6.

FIG. 8 is a layout view of another dummy pixel according to an illustrative embodiment of the present invention.

FIG. 9 is a cross-sectional view of a liquid crystal display taken along line IX-IX of FIG. 8.

### DETAILED DESCRIPTION OF THE EMBODIMENTS

The present invention will be described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. In the drawings, the thickness of layers, films, panels, regions, etc., are exaggerated for clarity. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

Now, a display device according to an exemplary embodiment of the present invention will be described in detail with reference to the accompanying drawings.

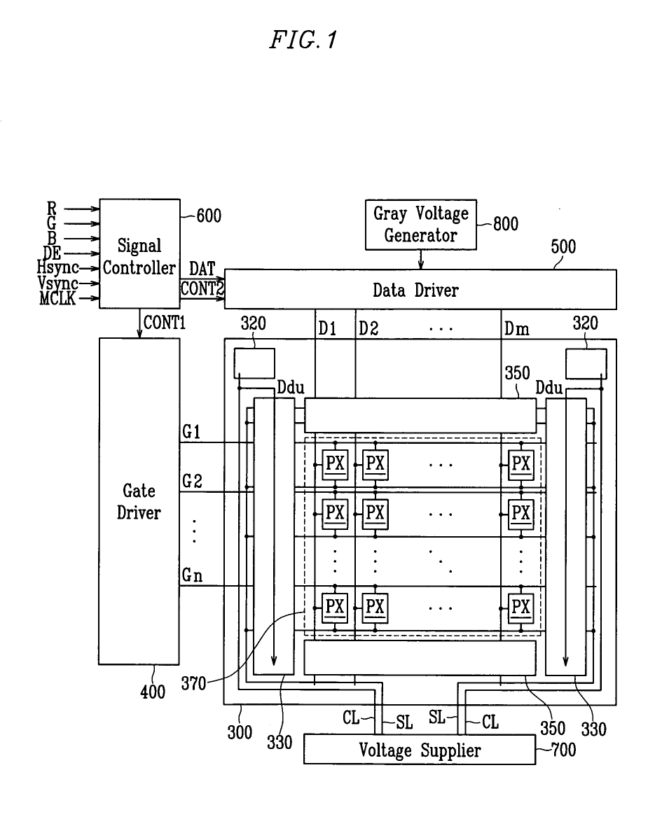

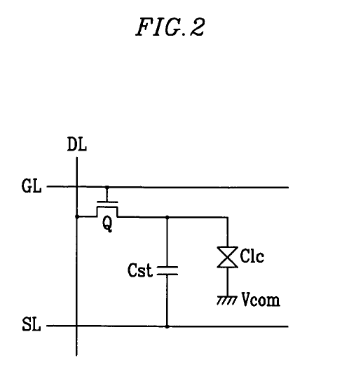

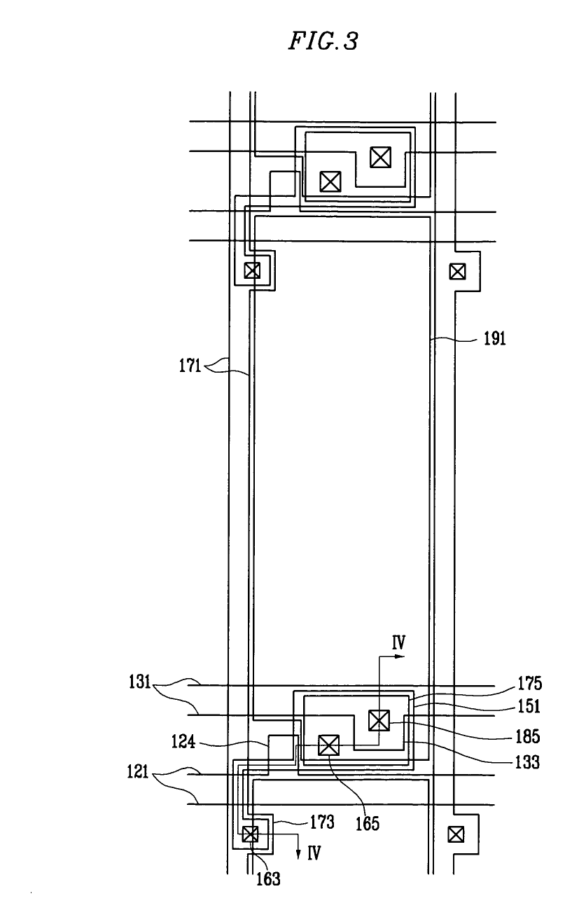

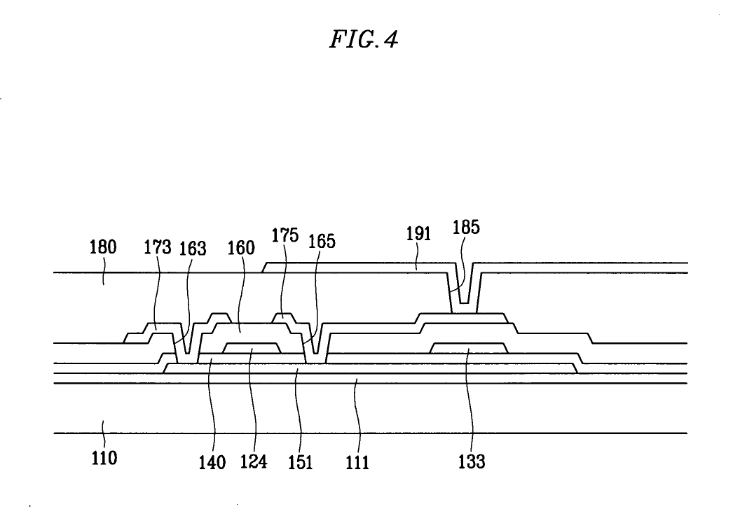

FIG. 1 is a block diagram of a liquid crystal display according to an illustrative embodiment of the present invention, FIG. 2 is an equivalent circuit diagram of a display pixel of a liquid crystal display according to an illustrative embodiment of the present invention, and FIG. 3 is a layout view of a display pixel of a liquid crystal display according to an illustrative embodiment of the present invention. FIG. 4 is a cross-sectional view of a liquid crystal display taken along line IV-IV of FIG. 3.

As shown in FIG. 1, the liquid crystal display according to an exemplary embodiment of the present invention includes a liquid crystal panel assembly 300, a gate driver 400 and a data driver 500 that are connected thereto, a gray voltage generator 800 that is connected to the data driver 500, a voltage supplier 700, and a signal controller 600 for controlling the data driver 500 and the gate driver 400.

The liquid crystal panel assembly 300 includes a display area 370 including a plurality of display pixels PX and dummy areas 330 and 350 including a plurality of dummy pixels.

The display area 370 includes a plurality of signal lines (G₁-Gₙ, D₁-Dₘ), and a plurality of display pixels PX that are connected thereto and arranged approximately in a matrix shape.

The signal lines (G₁-Gₙ, D₁-Dₘ) include a plurality of gate lines (G₁-Gₙ) for transferring a gate signal (referred to as “scanning signal”) and a plurality of data lines (D₁-Dₘ) for transferring a data voltage. The gate lines (G₁-Gₙ) extend approximately in a row direction and are substantially parallel to each other, while the data lines (D₁-Dₘ) extend approximately in a column direction and are substantially parallel to each other.

Furthermore, the liquid crystal panel assembly 300 includes a plurality of storage electrode lines SL for transferring a sustain voltage across the display area 370 and the dummy areas 330 and 350. The storage electrode lines SL extend approximately in a row direction, are substantially parallel to each other, and ends of the storage electrode lines thereof are connected to each other. The liquid crystal panel assembly 300 further includes a common voltage supply line CL that is positioned in an edge of the liquid crystal panel assembly 300 and that transfers a common voltage Vcom.

Referring to FIG. 2, each display pixel PX, for example a display pixel PX that is connected to i-th (i=1, 2, . . . , n) gate line (Gi) and j-th (j=1, 2, . . . , m) data line (Dj), includes a switching element Q that is connected to the signal line (Gi, Dj), and a liquid crystal capacitor Clc and a storage capacitor Cst that are connected thereto.

The switching element Q is a three terminal element such as a thin film transistor, and a control terminal thereof is connected to the gate line (Gi), an input terminal thereof is connected to the data line (Dj), and an output terminal thereof is connected to the liquid crystal capacitor Clc and the storage capacitor Cst.

The liquid crystal capacitor Clc is a capacitor having a liquid crystal layer as a dielectric material and that transmits light by changing the arrangement of liquid crystals depending on a data voltage supplied from the switching element Q.

The storage capacitor Cst is formed between the storage electrode line SL and the output terminal of the switching element Q and maintains a charge voltage of the liquid crystal capacitor Clc.

Hereinafter, referring to FIGS. 3 and 4, a display pixel PX according to an exemplary embodiment of the present invention will be described in detail.

A blocking film 111 that is made of silicon oxide (SiO₂), silicon nitride (SiNx), or so on is formed on a transparent insulation substrate 110. The blocking film 111 may, but need not, have a multiple-layered structure.

A plurality of semiconductor islands 151 that may, but need not, be made of polycrystalline silicon are formed on the blocking film 111.

The semiconductor island 151 is an amorphous silicon crystal that may, but need not, be made through a sequential side solid phase crystallization process. Each semiconductor 151 includes an extrinsic region that contains a conductive impurity and an intrinsic region that contains almost no conductive impurity.

The extrinsic region may further include a heavily doped region having a high impurity concentration and a lightly doped region having a low impurity concentration.

The intrinsic region of the semiconductor island 151 includes a channel region, and the heavily doped extrinsic region includes a plurality of source/drain regions that are separated from each other about the channel region.

The lightly doped extrinsic region positioned between the source/drain regions and the channel region is called a lightly doped drain region (LDD region), and the width thereof is narrower than that of other regions.

The semiconductor island 151 is widely expanded after bending to the right side, while extending from a corner part under the left side to the upper side with a narrow width.

The conductive impurity of the semiconductor island 151 includes a P-type impurity such as boron (B) and/or gallium (G), and an N-type impurity such as phosphorus (P) and/or arsenic (As). The lightly doped region prevents a leakage current of a thin film transistor or a punch-through phenomenon from being generated, and may be replaced using an offset region with no impurity.

A gate insulating layer 140 that is made of silicon nitride or silicon oxide is formed on the semiconductor 151 and the blocking film 111.

A plurality of gate lines 121 and a plurality of storage electrode lines 131 that extend in a horizontal direction and have gate electrodes 124 are formed on the gate insulating layer 140. The gate line 121 transfers a gate signal, and the gate electrode 124 protrudes to the upper side to overlap with the channel region of the semiconductor 151. The gate electrode 124 may be overlapped with the lightly doped region. One end part of the gate line 121 is directly connected to the gate driver 400.

The storage electrode line 131 receives, for example, a predetermined sustain voltage, and includes the storage electrode 133 that is expanded to the lower side to overlap with the widely expanded semiconductor 151. The storage electrode line 131 receives a voltage of about the same magnitude as a common voltage that is applied to a common electrode (not shown) when the semiconductor 151 is doped up to a region that is overlapped with the storage electrode 133. The storage electrode line 131 receives a higher voltage than a common voltage when the semiconductor 151 is not doped up to a region that is overlapped with the storage electrode 133.

The gate line 121 and the storage electrode line 131 may be made of aluminum metals such as aluminum (Al) or an aluminum alloy, silver metals such as silver (Ag) or a silver alloy, copper metals such as copper (Cu) or a copper alloy, molybdenum metals such as molybdenum (Mo) or a molybdenum alloy, chromium (Cr), thallium (T), titanium (Ti), and so on. However, they could but need not have a multi-layered structure including two conductive layers (not shown) that have different physical properties. One conductive layer among them is made of metals having low resistivity, for example, aluminum metals, silver metals, copper metals, or so on so as to reduce a signal delay or a voltage drop. Alternatively, another conductive layer is made of a material such as molybdenum metal, chromium, thallium, titanium, and so on having desirable physical, chemical, and electrical contact characteristics, and examples of such materials include ITO (indium tin oxide) and IZO (indium zinc oxide). A good example of such a combination may include a chromium lower layer and an aluminum (alloy) upper layer, and an aluminum (alloy) lower layer and a molybdenum (alloy) upper layer. However, the gate line 121, the storage electrode line 131, and the gate electrode 124 may made of various metals or electric conductors, in addition to or in lieu of the above-described materials.

Side surfaces of the gate line 121 and the storage electrode line 131 may be inclined relative to a surface of the substrate 110, and an exemplary inclination angle thereof is about 30° to 80°.

An interlayer insulating film 160 is formed on the gate line 121, the storage electrode line 131, and the gate insulating layer 140. The interlayer insulating film 160 is made of a non-organic insulator, an organic insulator, or so on, and a surface thereof may be flat. The non-organic insulator includes, for example, silicon nitride and silicon oxide. The organic insulator can have photosensitivity, and a dielectric constant thereof is preferably about 4.0 or less. However, the interlayer insulating film 160 may have a dual-layer structure of a lower inorganic layer and an upper organic layer.

A plurality of contact holes 163 and 165 for exposing each of the source region and the drain region are formed in the interlayer insulating film 160 and the gate insulating layer 140.

A plurality of data lines 171 and a plurality of drain electrodes 175 that have a plurality of source electrodes 173 are formed on the interlayer insulating film 160.

The data line 171 for transferring a data signal is extended in a substantially vertical direction to intersect the gate line 121, and the source electrode 173 is connected to the source region of the semiconductor 151 through the contact hole 163. One end part of the data line 171 may have a wide area so as to connect to other layers or an external driving circuit, and when a data driver (not shown) for generating a data signal is integrated on the substrate 110, the data line 171 can be directly connected to the data driver.

The drain electrode 175 is disposed apart from the source electrode 173 and is connected to the drain region of the semiconductor 151 through the contact hole 165. The drain electrode 175 is expanded and extended to overlap with the storage electrode 133.

The source electrode 153 and the drain electrode 155 substantially face each other about the gate electrode 124.

One gate electrode 124, one source electrode 173, one drain electrode 175, and the semiconductor 151 constitute one thin film transistor. A channel of the thin film transistor is formed in a channel region between the source electrode 173 and the drain electrode 175.

Illustratively, the data line 171 and the drain electrode 175 are made of a refractory metal such as molybdenum, chromium, thallium, and titanium, or their alloys. The data line 171 and the drain electrode 175 may have a multi-layered structure including a refractory metal layer (not shown) and a low resistance conductive layer (not shown). The multi-layered structure includes, for example, a double layer of a chromium or molybdenum (alloy) lower layer and an aluminum (alloy) upper layer, and a triple layer of a molybdenum (alloy) lower layer, an aluminum (alloy) middle layer, and a molybdenum (alloy) upper layer. However, the data line 171 and the drain electrode 175 may be made of various metals or an electric conductor, in addition to the above-described materials.

Illustratively, side surfaces of the data line 171 and the drain electrode 175 are also inclined with an inclination angle of about 30° to 80° to the surface of the substrate 110.

A passivation layer 180 is formed on the data line 171, the drain electrode 175, and the interlayer insulating film 160. The passivation layer 180 may be made of the same material as the interlayer insulating film 160, and has a plurality of contact holes 185 for exposing the drain electrode 175.

A pixel electrode 191 that is made of a transparent conductive material such as IZO or ITO or an opaque reflecting conductive material such as aluminum or silver is formed on the passivation layer 180.

The pixel electrode 191 is physically and electrically connected to the drain electrode 175 that is connected to the drain region 155 through the contact hole 185, and receives a data voltage from the drain region 155 and the drain electrode 175.

The pixel electrode 191 to which a data voltage is applied and a common electrode (not shown) of other display panels (not shown) to which a common voltage is applied generate an electric field, thereby determining a direction of liquid crystal molecules of a liquid crystal layer (not shown) between two electrodes. Polarization of light that passes the liquid crystal layer changes depending on the determined direction of liquid crystal molecules. The pixel electrode 191 and the common electrode constitutes a capacitor (hereinafter, referred to as “liquid crystal capacitor”), thereby maintaining an applied voltage even after the thin film transistor is turned off. The pixel electrode 191 is overlapped with the storage electrode 133 and the storage electrode line 131. A capacitor formed by overlapping of the pixel electrode 191 and the drain electrode 175 that is electrically connected thereto with the storage electrode line 131 or a capacitor formed by overlapping of the storage electrode line 131 and the semiconductor 151 is called a storage capacitor. The storage capacitor strengthens the voltage sustaining ability of the liquid crystal capacitor.

For color display, each display pixel (PX) uniquely displays one of a set of primary colors (i.e., spatial division), or each display pixel (PX) sequentially alternately displays each color in the set of primary colors (i.e., temporal division), such that a spatial or temporal sum of the primary colors is recognized as a desired color. An example of a set of primary colors includes red, green, and blue.

Referring again to FIG. 1, in the liquid crystal panel assembly 300, a lower substrate is connected to a voltage supplier 700 and includes a short point 320 for transferring a common voltage Vcom to a common electrode (not shown) of an upper substrate (not shown).

The dummy regions 330 and 350 that are formed in the liquid crystal panel assembly 300 include a first dummy region 330 that is formed in left/right edge regions of the display area 370 and a second dummy region 350 that is formed in upper/lower edge regions of the display area 370.

A plurality of dummy pixels (not shown) that are formed in the first dummy region 330 and the second dummy region 350 do not include a switching element, unlike the display pixel PX. Accordingly, the plurality of dummy pixels prevents static electricity from penetrating the display area 370. The switching element is destroyed when static electricity that is generated at the short point 320 is introduced.

The first dummy region 330 includes a plurality of dummy pixels (not shown) arranged in a column direction, and a dummy data line Ddu is formed in a column direction across a plurality of dummy pixels (not shown). At this time, the dummy data line Ddu is connected to the common voltage supply line CL for transferring the common voltage Vcom.

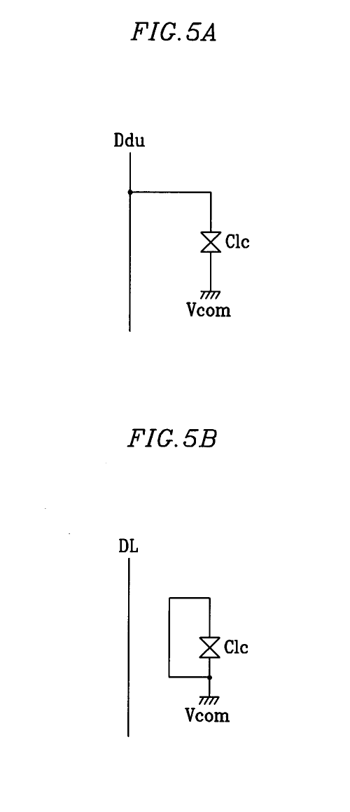

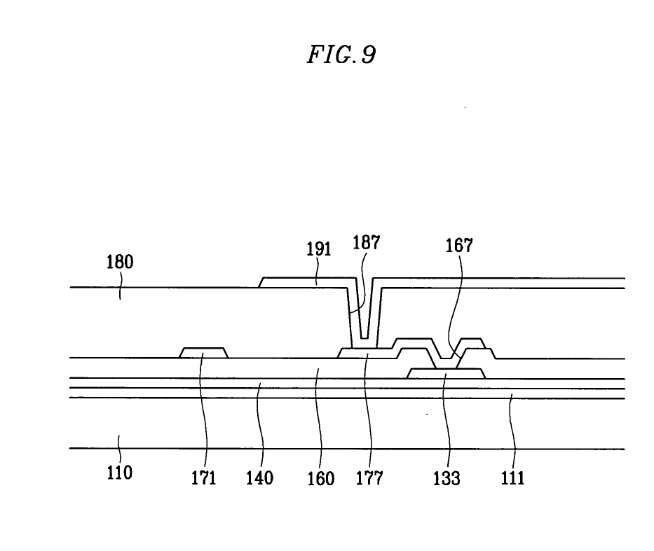

Hereinafter, a dummy pixel of a liquid crystal display according to an exemplary embodiment of the present invention will be described with reference to FIGS. 5 and 9.

FIGS. 5A and 5B are equivalent circuit diagrams for a dummy pixel according to an illustrative embodiment of the present invention.

FIG. 5A shows a dummy pixel (hereinafter, referred to as, “a first dummy pixel”) that is formed in the first dummy region 330, and the first dummy pixel includes a liquid crystal capacitor Clc.

In the liquid crystal capacitor Clc, one electrode thereof is connected to the dummy data line Ddu and another electrode thereof is connected to the common voltage Vcom. The arrangement of the liquid crystal changes depending on a voltage that is supplied to the dummy data line Ddu. At this time, a voltage that is supplied to the dummy data line Ddu may have the same magnitude as the common voltage Vcom.

FIG. 5B shows a dummy pixel (hereinafter, referred to as “a second dummy pixel”) that is formed in the second dummy region 350, and the second dummy pixel also includes the liquid crystal capacitor Clc.

The liquid crystal capacitor Clc receives an equal common voltage Vcom as two electrodes that are arranged about a liquid crystal layer are connected to each other.

The first dummy pixel and the second dummy pixel receive the equal common voltage Vcom from two electrodes and charge a voltage of 0V. Therefore, the arrangement of liquid crystal does not change. When the liquid crystal is TN (twisted nematic), the liquid crystal transmits light of the highest gray level.

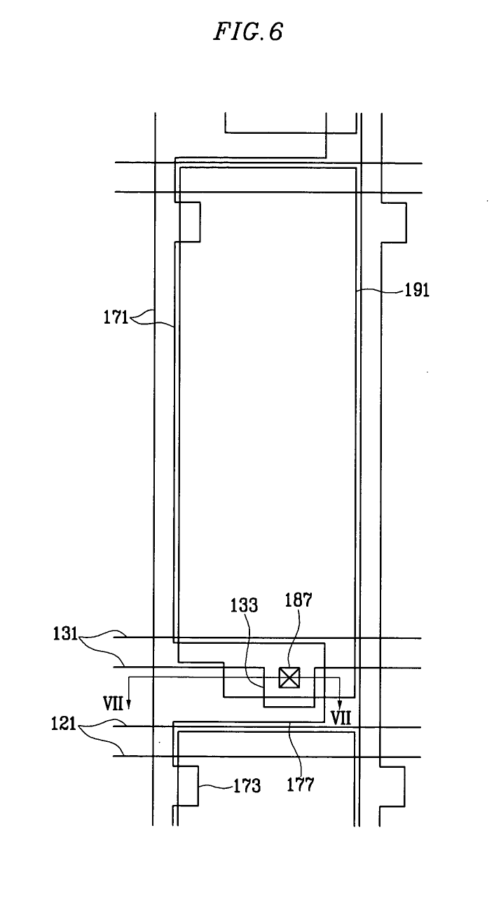

Hereinafter, the first dummy pixel and the second dummy pixel will be described in detail with reference to FIGS. 6 to 9.

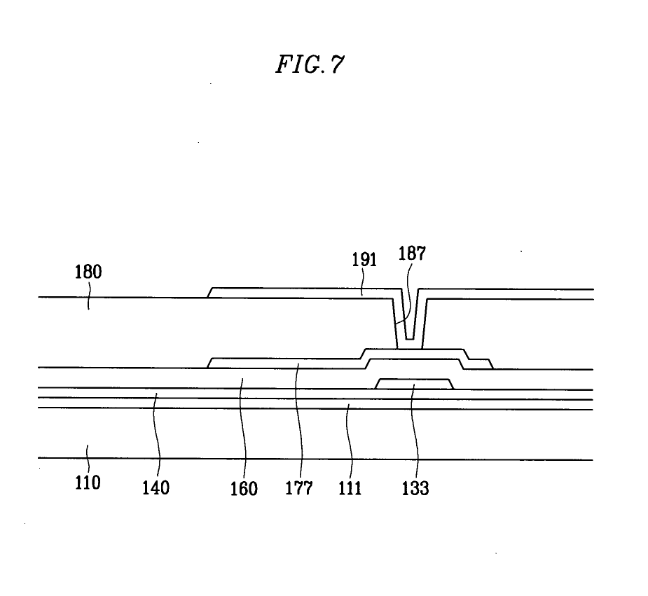

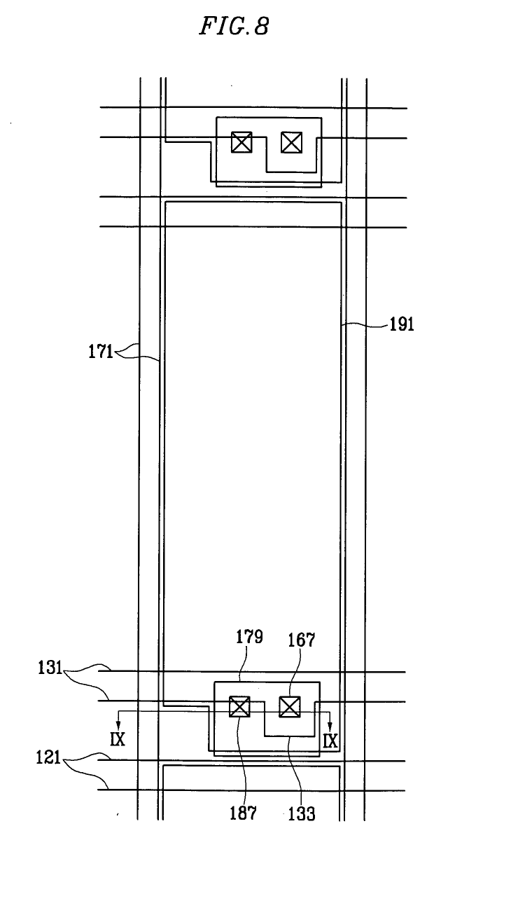

FIG. 6 is a layout view for the first dummy pixel according to an embodiment of the present invention, FIG. 7 is a cross-sectional view of a liquid crystal display taken along line VII-VII of FIG. 6, and FIG. 8 is a layout view for the second dummy pixel according to an embodiment of the present invention. FIG. 9 is a cross-sectional view of a liquid crystal display taken along line IX-IX of FIG. 8.

A blocking film 111 is formed on the transparent insulation substrate 110 such as the display pixel PX.

A gate insulating layer 140 is formed on the blocking film 111, and a plurality of gate lines 121 and a plurality of storage electrode lines 131 that are extended in a horizontal direction are formed on the gate insulating layer 140. The plurality of gate lines 121 reaches the display area 370 across the first and second dummy regions 330 and 350 without being exposed in the first and second dummy regions 330 and 350. Therefore, the plurality of gate lines 121 of the second dummy region 350 can be removed.

The storage electrode line 131 receives a predetermined sustain voltage and includes a storage electrode 133 extended in a downward direction. Sustain voltages that are applied to the first dummy region 330 and the second dummy region 350 may be equal to or different from each other. Specifically, the storage electrode line 131 of the second dummy region 350 receives the common voltage Vcom.

The interlayer insulating film 160 is formed on the gate line 121, the storage electrode line 131, and the gate insulating layer 140. A plurality of contact holes 167 for exposing the storage electrode 133 of the second dummy region 350 is formed in the interlayer insulating film 160.

A plurality of dummy data lines Ddu 171 that is formed in the first dummy region 330 and a plurality of data lines 171 and a plurality of connection members 179 that are extended up to the display area 370 across the second dummy region 350 are formed on the interlayer insulating film 160.

The dummy data line Ddu 171 that is formed in the first dummy region 330 is mainly extended in a vertical direction to intersect the gate line 121, and includes a protruded part 177 that is protruded to the right side toward the storage electrode 133.

The plurality of data lines 171 that are formed in the second dummy region 350 are extended in a vertical direction and extended up to the display area 370 across the second dummy region 350 without being exposed in the second dummy region 350. The connection member 179 that is formed in the second dummy region 350 is overlapped with the storage electrode 133 and connected to the storage electrode 133 through the contact hole 167 of the interlayer insulating film 160.

The passivation layer 180 is formed on the dummy data line Ddu 171, the data line 171, the connection member 179, and the interlayer insulating film 160. The passivation layer 180 may be made of the same material as the interlayer insulating film 160, and has a plurality of contact holes 187 for exposing the protruded part 177 of the first dummy region 330 and the connection member 179 of the second dummy region 350.

The pixel electrode 191 that is made of a material such as IZO or ITO is formed on the passivation layer 180.

The pixel electrode 191 of the first dummy region 330 is connected to the protruded part 177 through the contact hole 187 and receives the common voltage Vcom through the dummy data line Ddu 171 and the protruded part 177.

Furthermore, the pixel electrode 191 of the second dummy region 350 is connected to the connection member 179 through the contact hole 187 and receives the common voltage Vcom through the storage electrode 133 and the connection member 179.

The potential difference is not generated between the pixel electrode 191 to which the common voltage Vcom is applied and a common electrode (not shown) of another substrate (not shown) to which the common voltage Vcom is applied, so that an electric field is not generated. Therefore, the direction of liquid crystal molecules is not changed in a liquid crystal layer (not shown) between two electrodes, thereby transmitting light of the highest gray level.

In this way, by directly applying the common voltage Vcom to the pixel electrode 191 of the first dummy pixel and the second dummy pixel, a shock-absorbing effect for external static electricity can be obtained without the switching element, so that it is possible to prevent static electricity from being introduced in the display area 370.

Referring again to FIG. 1, the gray voltage generator 800 generates two sets of gray voltages (or two sets of reference gray voltages) relevant to transmittance of the display pixel PX. A first set of the gray voltages or reference gray voltages has a positive value for the common voltage Vcom. A second set of the gray voltages or reference gray voltages has a negative value.

The gate driver 400 is connected to the gate lines (G1-Gn) of the liquid crystal panel assembly 300 to apply a gate signal consisting of a combination of a gate-on voltage Von and a gate-off voltage Voff to the gate lines (G1-Gn).

The data driver 500, connected to the data lines (D1-Dm) of the liquid crystal panel assembly 300, selects a gray voltage from the gray voltage generator 800, and applies the gray voltage as a data voltage to the data lines (D1-Dm).

The voltage supplier 700, connected to the common voltage supply line CL and the storage electrode line SL of the liquid crystal panel assembly 300, supplies a sustain voltage to the storage electrode line SL, and supplies a common voltage Vcom to the common voltage supply line CL. At this time, the sustain voltage and the common voltage Vcom may have the same magnitude.

The signal controller 600 controls the gate driver 400 and the data driver 500.

Each of the drivers 400, 500, 800, 700, and 600 may, but need not, be directly mounted on the liquid crystal panel assembly 300 in a form of at least one integrated circuit chip, mounted on a flexible printed circuit film (not shown) to attach to the liquid crystal panel assembly 300 in a form of TCP (tape carrier package), or mounted on a separate printed circuit board (PCB) (not shown). Alternatively or additionally, the drivers 400, 500, 800, 700, and 600, the signal lines (G1-Gn, D1-Dm), the thin film transistor switching element Q, and so on may be integrated in the liquid crystal panel assembly 300. Furthermore, the drivers 400, 500, 800, 700, and 600 may be integrated in a single chip. In this case, at least one among them or at least one circuit element constituting them may be disposed at the outside of a single chip.

According to the present invention, by removing a thin film transistor of a dummy pixel and directly applying a common voltage to a pixel electrode, the thin film transistor of the dummy pixel is destroyed when static electricity is introduced from the outside, thereby preventing static electricity from being introduced to the display area.

While illustrative embodiments of this invention have been described in connection with what are presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a display area having display pixels arranged in a matrix; and
a dummy area proximate to an edge of the display area that has a plurality of dummy pixels,
wherein each dummy pixel comprises
a first electrode,
a second electrode receiving a common voltage,
a liquid crystal layer formed between the first electrode and the second electrode, and
a voltage supplier supplying a first voltage to the first electrode.

2. The display device of claim 1, wherein the first voltage is the common voltage.

3. The display device of claim 2, wherein the dummy area comprises:
a plurality of first dummy pixels formed in a column direction proximate to left/right edge regions of the display area; and
a plurality of second dummy pixels formed in a row direction proximate to upper/lower edge regions of the display area.

4. The display device of claim 3, wherein the voltage supplier comprises a dummy data line that crosses the plurality of first dummy pixels.

5. The display device of claim 4, wherein the dummy data line supplies the common voltage from the second electrode to the first electrode.

6. The display device of claim 3, wherein the plurality of second dummy pixels further comprises a sustain electrode line that is connected to each of the plurality of second dummy pixels to transfer the common voltage to each of the plurality of second dummy pixels.

7. The display device of claim 6, wherein the voltage supplier of the plurality of second dummy pixels transfers the common voltage of the storage electrode line to the first electrode.

8. The display device of claim 1, wherein the liquid crystal layer transmits light of the highest gray level when the potential difference between the first electrode and the second electrode is about 0V.

9. A display device comprising:
a dummy area proximate to an edge of a display panel having a matrix shape, the dummy area including a plurality of dummy pixels,
wherein the plurality of dummy pixels comprises:
a voltage supplier transferring a common voltage;
a first insulating layer that is formed on the voltage supplier and that comprises a contact hole at least partially exposing the voltage supplier;
a first electrode that is formed on the first insulating layer and that is connected to the voltage supplier through the contact hole;
a second electrode receiving a common voltage; and
a liquid crystal layer formed between the first electrode and the second electrode.

10. The display device of claim 9, wherein the plurality of dummy pixels comprises:
a plurality of first dummy pixels formed in a column direction proximate to left/right edge regions of the display panel; and
a plurality of second dummy pixels formed in a row direction proximate to upper/lower edge regions of the display panel.

11. The display device of claim 10, wherein the voltage supplier of the first plurality of dummy pixels supplies the common voltage from the second electrode to the first electrode.

12. The display device of claim 10, wherein the second plurality of dummy pixels further comprises a storage electrode that supplies the common voltage and that is under the voltage supplier.

13. The display device of claim 12, wherein the second plurality of dummy pixels further comprises a second insulating layer that comprises a contact hole for connecting the storage electrode and the voltage supplier on the storage electrode.

14. The display device of claim 9, wherein the liquid crystal layer transmits light of the highest gray level when the potential difference between the first electrode and the-second electrode is about 0V.
